(19) United States
(12) Patent Application Publication
(10) Pub. No.: US 2009/0026831 A1
(43) Pub. Date: Jan. 29, 2009

(54) Modular and variable offset adjustment for multi-piece wheels and method of universal replacement of center discs for multi-piece wheels

(76) Inventor: Scott F. Acker, Miami, FL (US)

Correspondence Address: MELVIN K. SILVERMAN AND ASSOCS PC, 500 WEST CYPRESS CREEK ROAD, SUITE 350, FT. LAUDERDALE, FL, 33309, US

(21) Appl. No.: 11/881,122

(22) Filed: Jul. 25, 2007

(51) Int. Cl. B60B 25/04; B23P 19/00; B60B 25/22

(52) U.S. Cl. 301/11.3; 29/802; 301/64.101

(57) ABSTRACT

An adapter ring for an auto wheel system includes a flat annular ring having a transverse center axis and circumferential holes positioned radially off of a virtual annular center circumference of the ring in a direction of a transverse center axis. The ring is used in a system including a wheel system having an auto wheel barrel including an inner annular flange located at an axial offset outward of a radial centerline of the barrel, the flange having a circumferential multiplicity of threaded axial recesses. Upon the inner annular flange, an annular adapter ring is proportioned for flush orientation upon the flange and circumferentially against an inner surface of an interior diameter of the barrel immediately above the flange, the ring including circumferential holes. Located conformally to the recesses of the annular flange of the barrel is a selectable center disc proportioned for complemental placement within an outer end of the barrel upon the adapter ring, the disc including an annular inner interface for engagement against an outer surface of the adapter ring, the interface including an annular axially inward projection for press-fittable contact against an interior diameter of the adapter ring, the center disc having its circumferential threaded holes conformal in position to the holes of the ring and the recesses of the barrel annular flange. Also, included are and bolts having threadings complemental to that of the holes and recesses, the bolts threadable into the flange recesses to effect a secure fastening of the disc, adapter ring and flange together.

### BACKGROUND OF THE INVENTION

In the area of vehicle wheels and aftermarket replacement wheels (sometimes referred as rims) upon automobiles, an auto owner or user of a car may occasionally wish to change the entire wheel or simply the appearance of the vehicle's wheels. Today, it is possible to purchase a wide variety of different aftermarket wheels and or rims ranging from one-piece, two-piece and three-piece applications. Specifically to this patent, the types of wheels that this invention will apply to are the two-piece and three-piece wheels also known as multi-piece wheels. Car owners often consider the appearance of their wheels/rims as an extension of their personality or at least that of their vehicle. Therefore, upon new ownership of a vehicle, one might feel it necessary to modify the vehicle to their own style, such as a change in paint color, of the vehicle. For that same reason, the owner may wish to make a change in the appearance of the wheel to further create a more individualistic look for the vehicle.

In the past, to change the ascetics of a vehicle's wheels, it has been necessary to purchase an entirely new set of wheels. This entailing considerable costs. While two-piece wheels, also termed dual vehicle wheel assemblies are known in the art (see for example U.S. Pat. No. 6,641,224 to Heck, entitled Full Face Vehicle Wheel For Use In Offset Tool Vehicle Wheel Assembly), there does not exist a system in which the center disc, that is, the outer/center visible portion of the wheel may be reliably interchanged without change of the entire wheel barrel itself.

The concept of an interchangeable wheel center disc is shown in Japanese Patent No. 08-48105 (1996) to Masanobu and in European Patent Specification 0 412 275A1 (1990). However, provision of direct contact between the ornamental center disc of wheel system and the wheel itself entails a number of safety and other practical issues including the provision of appropriate space within what is termed the X-factor of the wheel, that being the space within which the brake calipers of a braking system must reside. Accordingly, it is often the case where one wishes to effect direct attachment of a center disc to the inner peripheral surface of the wheel's barrel, that sufficient space for normal or safe operation of the wheel calipers is not available. The present invention addresses this problem through the provision of a special adapter ring or Offset Ring or ET Ring which functions to increase the offset between the innermost surface of the center disc, known as the disc backpad, and the so-called radial centerline of the wheel barrel. The invention addresses this long-felt need in the art. The offset of a wheel is the measurement from the centerline of the wheel to the back-pad of the wheel's center disk or otherwise known as the wheel center flange. This distance is primarily measured in millimeters. The offset of a wheel ultimately determines the wheel's proper fitment within the vehicle's wheel well.

### SUMMARY OF THE INVENTION

A method for providing replacements of center discs of an multi-piece automotive wheel, includes the steps of providing a wheel barrel with an inner annular flange located at an axial offset outward of a radial centerline of said barrel, said flange having a circumferential multiplicity of threaded axial recesses therein; providing upon said inner annular flange, an annular adapter ring proportioned for flush orientation upon said flange and circumferentially against an inner surface an interior diameter of said barrel immediately outward of said flange, said ring including a multiplicity of circumferential holes transversely therethrough, locatable conformally to said recesses of said annular flange of said barrel; providing a center disc proportioned for complemental placement within said wheel barrel upon said adapter ring, said disc including an annular interface for engagement against said adapter ring, said interface including an annular axially inward projection proportioned for press-fittable contact against an interior diameter of said adapter ring, said center disc having a circumferential multiplicity of threaded holes conformal in position to said holes of said ring and said recesses of said annular barrel flange; and providing bolts having threading thereon complemental to that of said holes and recesses, to effect a secure fastening of said disc ring and annular flange together, and to, said annular flange.

It is the object of the present invention to provide a means to modularly increase the Offset measurements (or ET Measurements) by adding the invention otherwise known as the ET Ring or Offset Ring between the center disk and the annular inner flange of the wheel barrel. A specific byproduct of the modular expansion capabilities of this invention is the increase of the Offset measurement without the decrease of the wheel's X-Factor measurement.

It is another object to provide a method by which the center disc of a wheel barrel may be conveniently and safely changed without need for replacement of the entire wheel barrel in order to modify the external appearance of the vehicle's wheels.

A further object is to provide a novel adapter ring by which the above objects may be facilitated.

The above and yet other objects and advantages of the present invention will become apparent from the hereinafter set forth Brief Description of the Drawings, Detailed Description of the Invention and the Claims appended herewith.

### BRIEF DESCRIPTION OF THE DRAWINGS

FIG. 1 is an exploded view showing the basic elements of the present invention as it would be used with a two-piece wheel.

FIG. 2 is a diametric axial cross-sectional assembly view of the present invention.

FIG. 3 is an enlarged view of the upper left hand portion of FIG. 2.

FIG. 4 is a perspective view of the adapter ring of the present invention.

FIG. 5 is an enlarged view of a segment of the adapter ring.

### DETAILED DESCRIPTION OF THE INVENTION

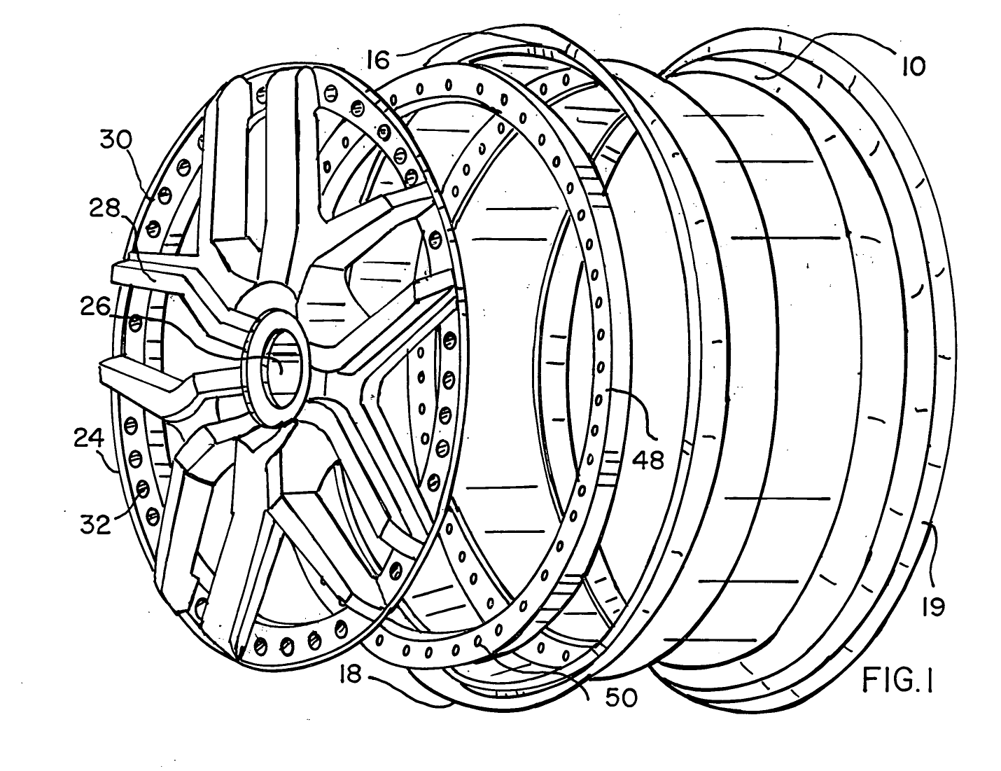

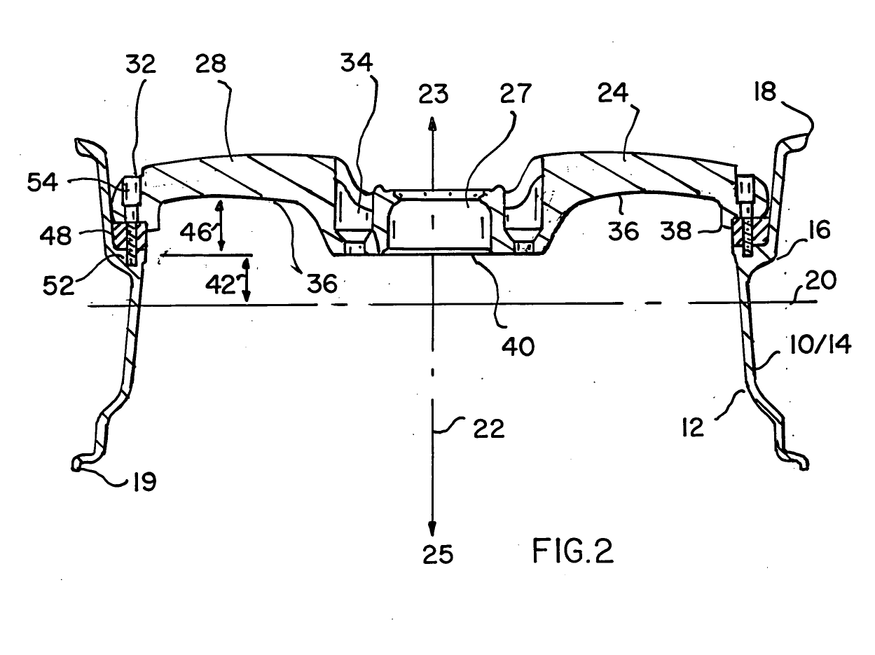

With reference to the views of FIGS. 1 and 2, a wheel hub system in accordance with the present invention may be seen to include an auto wheel barrel 10 having an inside portion 12 and an outside portion 14. Material portions of said barrel 10 include an inner annular flange 16, an outer lip 18, and an inner lip 19. The barrel 10 is also definable in terms of a radial centerline 20 and an axis 22 extending from an outward end 23 to an inward end 25. In FIGS. 1 and 2 are also shown a center disc 24 which represents the ornamental external portion of a wheel of an automobile. Said disc 24 includes a centerbore 26, radial arms 28 and a circumferential belt 30 which includes therein a multiplicity of circumferential holes 32 therein. As may be noted in FIG. 2, center disc 24 also includes axially inner holes 34 which are used to bolt the center disc and hub 10 to an axle interface of an automobile axle.

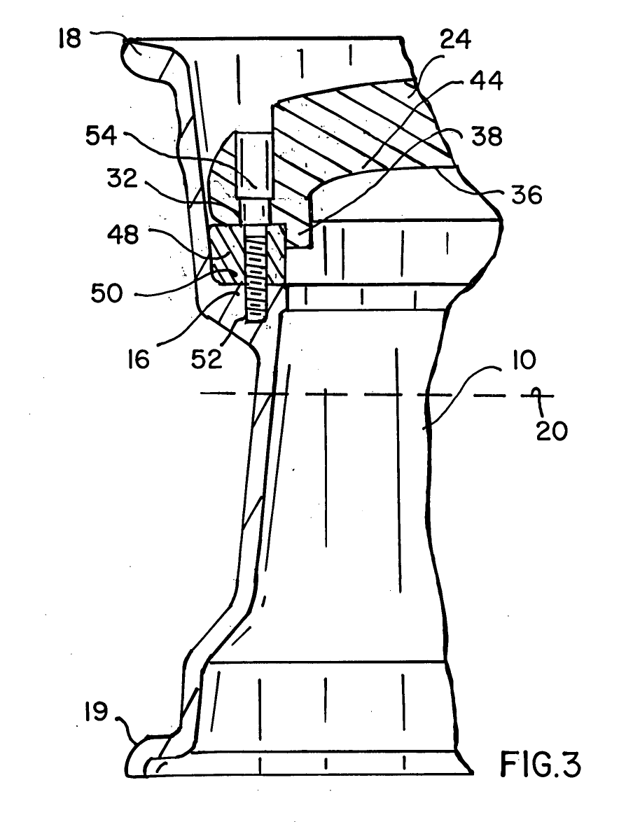

Inner surface 36 of center disc 24 is characterized, at an outer portion of the interior diameter thereof, by an annular axially inwardly projecting element 38 (see FIGS. 2 and 3) having an axis substantially co-parallel with axis 22 of the entire system, said element 38 assisting in the securing in position of a ring 48 (discussed below).

Surface 40, at a center of inner side 36 of center disc 18 comprises a backpad 40 of the disc. The inner axial dimension thereof is, in the prior art, varied to facilitate flush engagement between the backpad and the interface to the wheel hub of the automobile. In given center disc designs, the amount of material that must necessarily be removed from backpad 40 can be substantial. It is also noted that the actual distance between the backpad and radial centerline 20 is known as the offset or ET 42 of the wheel. Also, dimension 46, between backpad 40 and the inner surface 36 of center disc 24, is known as an X-factor 46 of the hub, this region comprising the location of the brake calipers by which rotation of the wheels relative to the vehicle is controlled by the brakes of the automobile. Accordingly, the safety of a vehicle may be affected if an excessive amount of material is removed from backpad 40 and, in the prior art, such has occurred where a driver wishes to change to use of certain wheel for ornamental or aesthetic purposes.

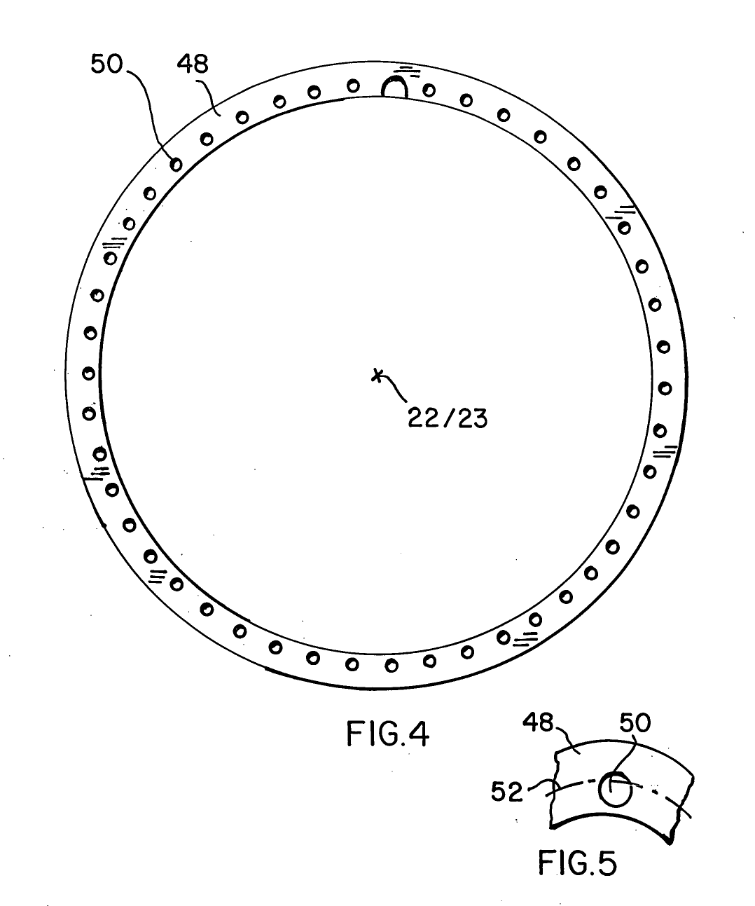

In FIGS. 1 and 2 there is shown adapter ring 48 which facilitates securement of that center disc 24, of a type having particular appeal to the end user, to said annular barrel flange 16 of barrel 10. The ring-flange interface may be more fully appreciated with reference to the enlarged view of FIG. 3. Therein, and in FIGS. 4 and 5, adapter ring 48 may be seen to include a multiplicity of circumferential holes 50 which may be co-located with circumferential holes 32 of the center disc and, as well, are complemental in location with recesses 52 of annular barrel flange 16. As may be noted in FIGS. 2 and 3, through the use of bolts 54, all parts of the system, namely, center disc 24, adapter ring 48 and barrel flange 16 may be reliably secured thereby enabling a user to change the ornamental exterior center disc without buying an entirely new wheel hub. This method is also of value to the auto accessory supplier or distributor in that he thereby is able to stock a volume of center disks proportion to the volume of wheels barrels however at the same time keep a wide variety the center disk designs on hand. By stocking different center discs, all of which may, through the use of adapter rings of differing thicknesses in a range, for example, of between about 5 and about 30 millimeters, to enable placement upon a common diameter barrel 10 while allowing a sufficient offset (ET) and X-factor 46

As may be noted in FIG. 5, holes 50 are radially off-center from radial center 52 in a direction of center axis 22 of the disc 48.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

I claim:

1. A method for providing replacements of center discs of a wheel, the method comprising the steps of:
(a) providing an auto wheel barrel with an inner annular flange located at an axial offset outward of a radial centerline of said barrel, said flange having a circumferential multiplicity of threaded axial recesses therein;
(b) providing upon said inner annular flange, an annular adapter ring proportioned for flush orientation upon said flange and circumferentially against an inner surface an interior diameter of said barrel immediately outward of said flange, said ring including a multiplicity of circumferential holes transversely therethrough, locatable conformally to said recesses of said annular flange of said barrel;
(c) providing a center disc proportioned for complemental placement within said hub barrel upon said adapter ring, said disc including an annular interface for engagement against said adapter ring, said interface including an annular axially inward projection proportioned for press-fittable contact against an interior diameter of said adapter ring, said center disc having a circumferential multiplicity of threaded holes conformal in position to said holes of said ring and said recesses of said annular barrel flange; and
(d) providing bolts having threading thereon complemental to that of said holes and recesses, to effect a secure fastening of said disc ring and annular flange together, and to, said annular flange.

2. The method as recited in claim 1, further comprising the step of:
locating of said holes of said adapter ring radially off-center in a direction of a transverse center axis of said ring.

3. A wheel system, comprising:
(a) an auto wheel barrel having an inner annular flange located at an axial offset outward of a radial centerline of said barrel, said flange having a circumferential multiplicity of threaded axial recesses therein;
(b) upon said inner annular flange, an annular adapter ring proportioned for flush orientation upon said flange and circumferentially against an inner surface of an interior diameter of said barrel immediately above said flange, said ring including a multiplicity of circumferential holes axially therethrough, locatable conformally to said recesses of said annular flange of said barrel;
(c) a selectable center disc proportioned for complemental placement within an outer end of said barrel upon said adapter ring, said disc including an annular inner interface for engagement against an outer surface of said adapter ring, said interface including an annular axially inward projection for press-fittable contact against an interior diameter of said adapter ring, said center disc having a circumferential multiplicity of threaded holes conformal in position to said holes of said ring and said recesses of said barrel annular flange; and
(d) bolts having threadings thereon complemental to that of said holes and recesses, said bolts threadable into said flange recesses to effect a secure fastening of said disc, adapter ring and flange together.

4. The system as recited in claim 3, said adapter ring having said holes thereof radially off of annular center in a direction of transverse center axis of said ring.

5. An adapter ring for an auto wheel system, comprising:
a substantially flat annular ring having a transverse center axis and a circumferential multiplicity of holes therein, said holes positioned radially off of a virtual annular center circumference of said ring in direction of said center axis.
